(19) United States
(12) Patent Application Publication
(10) Pub. No.: US 2005/0128251 A1
(43) Pub. Date: Jun. 16, 2005

(54) Ink-jet printhead

(76) Inventors: You-seop Lee, Yongin-si (KR); Yong-soo Oh, Seongnam-si (KR); Seung-joo Shin, Seoul (KR)

Correspondence Address: LEE, STERBA & MORSE, P.C., 1101 WILSON BOULEVARD, SUITE 2000, ARLINGTON, VA, 22209, US

(21) Appl. No.: 11/010,270

(22) Filed: Dec. 14, 2004

(30) Foreign Application Priority Data
Dec. 16, 2003 (KR) 2003-91871

(51) Int. Cl. B41J 2/04

(52) U.S. Cl. 347/54

(57) ABSTRACT

An ink-jet printhead includes an ink flow path having a nozzle for ejecting ink, at least one pair of electrodes provided in the ink flow path, each of the at least one pair of electrodes being separated from each other, and a voltage application unit for applying a voltage between the at least one pair of electrodes to generate a plasma discharge caused by liquid ionization between the pair of electrodes to generate a bubble for ejecting the ink.

### BACKGROUND OF THE INVENTION

1. Field of the Invention

The present invention relates to an ink-jet printhead. More particularly, the present invention relates to an ink-jet printhead in which bubbles are generated by a liquid plasma discharge to eject ink.

2. Description of the Related Art

Generally, ink-jet printheads are devices for printing a predetermined image, color or black and white, by ejecting a small volume droplet of printing ink at a desired position on a recording sheet. Ink-jet printheads are generally categorized into two types depending on which ink ejection mechanism is used. A first type is a thermally driven ink-jet printhead, in which a heat source is employed to form and expand bubbles in ink causing ink droplets to be ejected. A second type is a piezoelectrically driven ink-jet printhead, in which a piezoelectric material is deformed to exert pressure on ink causing ink droplets to be ejected.

FIG. 1A illustrates an exploded perspective view of a configuration of a thermally driven ink-jet printhead. FIG. 1B illustrates a cross-sectional view for explaining a process of ejecting an ink droplet in the thermally driven ink-jet printhead of FIG. 1A.

Referring to FIGS. 1A and 1B, the conventional thermally driven ink-jet printhead includes a substrate 10, a barrier 14 installed on the substrate 10 to define an ink chamber 26 and an ink channel 24, a heater 12 installed on the bottom of the ink chamber 26, and a nozzle plate 18, in which a nozzle 16 for ejecting an ink droplet 29′ is formed. In operation, when a pulse current is applied to the heater 12 and heat is generated by the heater 12, ink 29 in the ink chamber 26 is boiled to generate a bubble 28. The generated bubble 28 continuously expands, thereby exerting pressure on the ink 29 in the ink chamber 26 to eject the ink droplet 29′ out of the printhead via the nozzle 16. Subsequently, ink 29 from a manifold 22 is supplied to the ink chamber 26 via the ink channel 24, thereby again filling the ink chamber 26 with ink 29.

However, in a thermally driven ink-jet printhead, a cavitation pressure generated when bubbles disappear is concentrated in a central portion of the heater 12, thereby deteriorating the heater 12.

FIG. 2 illustrates a cross-sectional view of another conventional ink-jet printhead, which attempts to solve a defect of a thermally driven printhead as described above.

Referring to FIG. 2, when a laser beam L generated from a laser light source 30 is irradiated onto predetermined color inks 32Y, 32M, and 32C filling ink containers 37Y, 37M, and 37C, respectively, light energy is transformed into sound energy, thereby generating bubbles in the inks 32Y, 32M, and 32C. Ink droplets are then ejected onto a sheet of paper 50 by the bubbles generated as described above and a required image is formed.

However, in the ink-jet printhead as described above, since a laser light source required to generate a high-energy laser beam is expensive and an optical configuration is complicated, it is difficult to miniaturize and integrate the ink-jet printhead.

FIG. 3 illustrates a cross-sectional view of still another conventional ink-jet printhead.

Referring to FIG. 3, an ink chamber 53 is filled with ink 51 including an electrolyte, and a pair of electrodes 52a and 52b is formed on a bottom surface of the ink chamber 53. When an electrolysis signal is applied from a signal generator 57 to the pair of electrodes 52a and 52b, ink electrolysis is performed around the electrodes 52a and 52b and gas bubbles 55a and 55b are generated and expanded. Subsequently, ink 51 in the ink chamber 53 is ejected in droplets 56 through a nozzle 54.

The ink-jet printhead as described above is advantageous in that it uses a small driving voltage, but is disadvantageous in that ink ejectivity is small, harmful gas may be generated, ink must have a high conductivity, and voltage switching for gas extinction is required.

### SUMMARY OF THE INVENTION

The present invention is therefore directed to an ink-jet printhead, which substantially overcomes one or more of the problems due to the limitations and disadvantages of the related art.

It is a feature of an embodiment of the present invention to provide an ink-jet printhead in which bubbles are generated by a liquid plasma discharge to eject ink, thereby printing images with high integration and high resolution.

It is another feature of an embodiment of the present invention to provide an ink-jet printhead having a simplified configuration and an increased lifetime.

It is still another feature of an embodiment of the present invention to provide an ink-jet printhead having a large ink ejectivity and avoids generating a harmful gas.

It is yet another feature of an embodiment of the present invention to provide an ink-jet printhead that has no restrictions on properties such as photosensitivity and conductivity with relation to an ink that may be used.

At least one of the above and other features and advantages of the present invention may be realized by providing an ink-jet printhead including an ink flow path having a nozzle for ejecting ink, at least one pair of electrodes provided in the ink flow path, each of the at least one pair of electrodes being separated from each other, and a voltage application unit for applying a voltage between the at least one pair of electrodes to generate a plasma discharge caused by liquid ionization between the pair of electrodes to generate a bubble for ejecting the ink.

The ink may be one of a dielectric liquid and a conductive liquid.

A gap between the at least one pair of electrodes may be approximately 1 μm to approximately 10 μm.

One of a direct current pulse voltage and an alternating current pulse voltage may be applied between the at least one pair of electrodes. The voltage applied between the at least one pair of electrodes may be greater than approximately 1 MV/m. The voltage may be applied between the at least one pair of electrodes for a time of approximately 0.1 to approximately 10 μs.

The ink flow path may include an ink chamber to be supplied with ink to be ejected through the nozzle and an ink channel to supply ink to the ink chamber. The at least one pair of electrodes may be provided in the ink chamber. The at least one pair of electrodes may be provided on a bottom surface of the ink chamber. Alternatively, the at least one pair of electrodes may be provided in the ink channel. As a further alternative, the at least one pair of electrodes may be provided in the ink chamber and the ink channel.

The at least one pair of electrodes may be a plurality of pairs of electrodes. The ink flow path may include an ink chamber to be supplied with ink to be ejected through the nozzle and a plurality of ink channels to supply ink to the ink chamber, wherein one pair of the plurality of pairs of electrodes is provided in each of the plurality of ink channels.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1A illustrates an exploded perspective view of a conventional thermally driven ink-jet printhead;

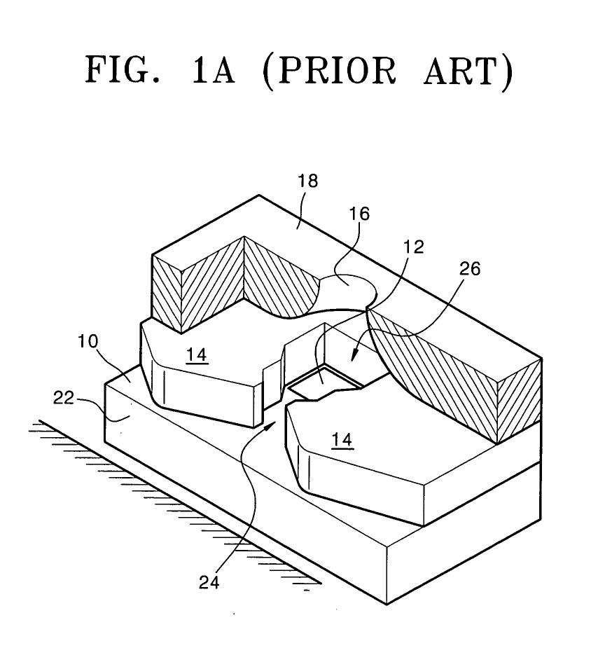

FIG. 1B illustrates a cross-sectional view for explaining a process of ejecting an ink droplet from the conventional thermally driven ink-jet printhead of FIG. 1A;

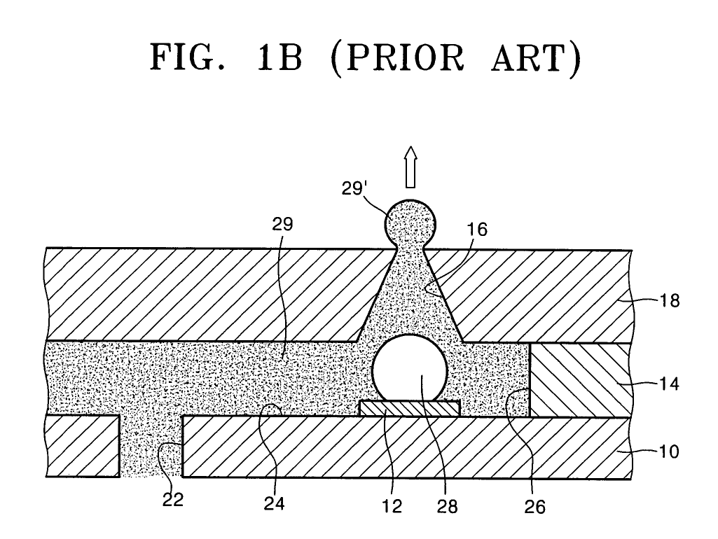

FIG. 2 illustrates a cross-sectional view of another conventional ink-jet printhead;

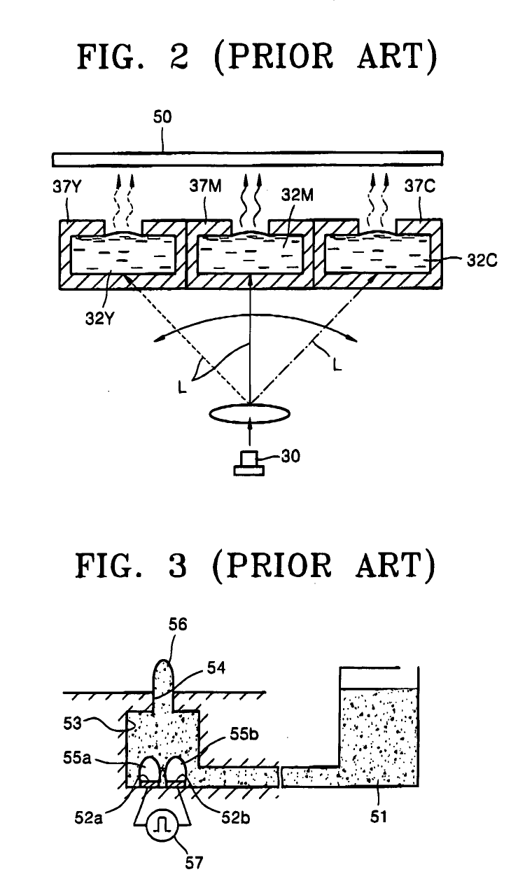

FIG. 3 illustrates a cross-sectional view of still another conventional ink-jet printhead;

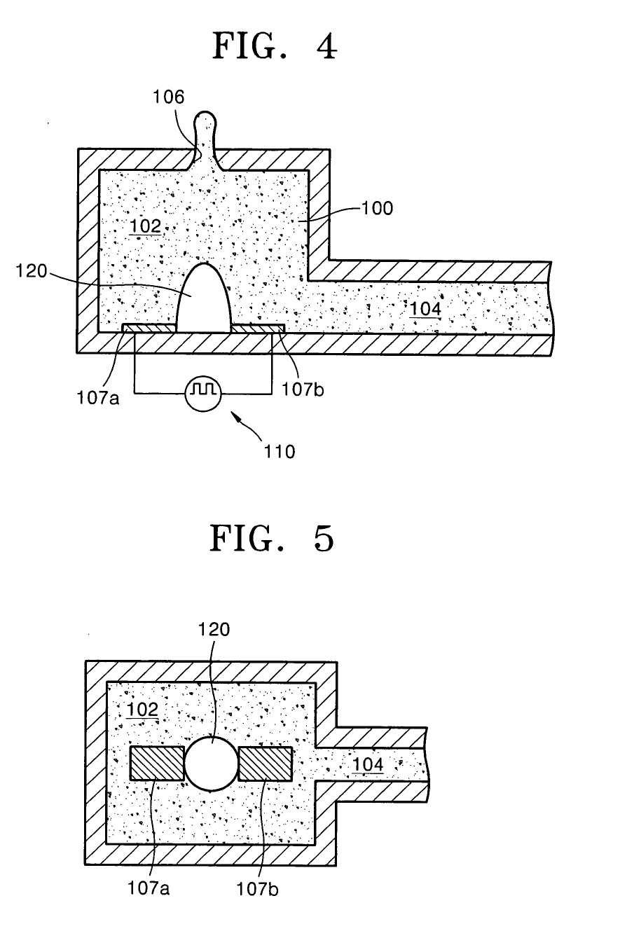

FIG. 4 illustrates a cross-sectional view of an ink-jet printhead according to an embodiment of the present invention;

FIG. 5 illustrates a top view of an interior of the ink-jet printhead of FIG. 4;

FIGS. 6A through 6C illustrate stages in a droplet ejection process of the ink-jet printhead according to an embodiment of the present invention; and

FIGS. 7 through 9 illustrate various modifications of the ink-jet printhead according to an embodiment of the present invention.

### DETAILED DESCRIPTION OF THE INVENTION

Korean Patent Application No. 2003-91871, filed on Dec. 16, 2003, in the Korean Intellectual Property Office, and entitled: “Ink-jet Printhead,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Like reference numerals refer to like elements throughout.

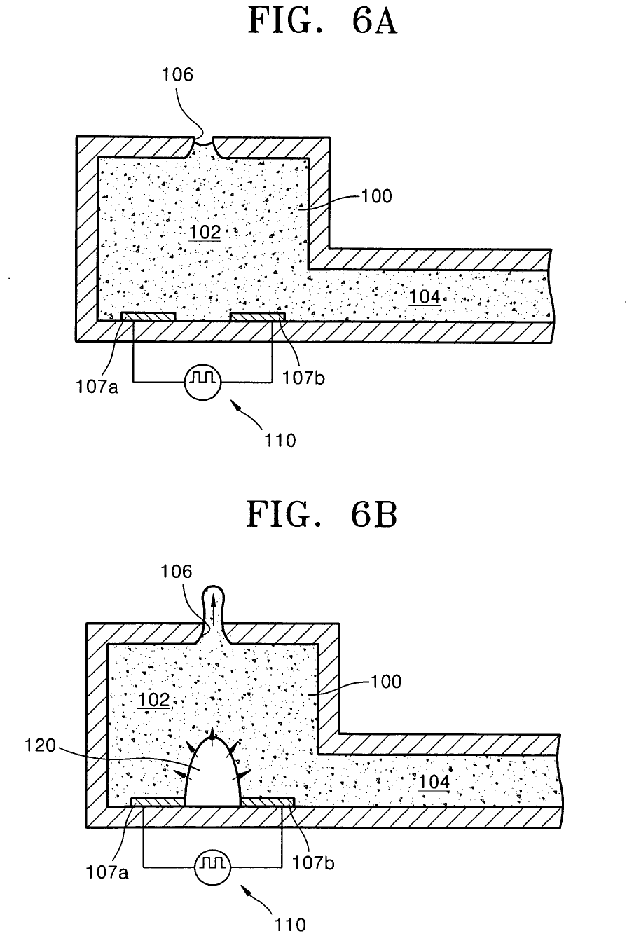

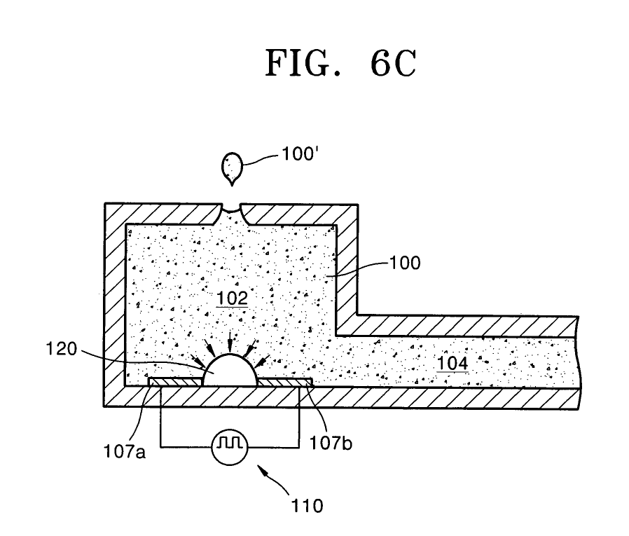

FIGS. 4 and 5 illustrate a cross-sectional view and a top view, respectively, of an ink-jet printhead according to an embodiment of the present invention.

Referring to FIGS. 4 and 5, the ink-jet printhead according to an embodiment of the present invention includes an ink flow path having a nozzle 106 through which ink 100 is ejected out of the printhead, a pair of electrodes 107a and 107b provided in the ink flow path, and a voltage application unit 110 for applying a voltage between the pair of electrodes 107a and 107b.

The ink flow path may include an ink chamber 102 and an ink channel 104. The ink chamber 102 is a space that is filled with ink 100 to be ejected through the nozzle 106. The ink channel 104 is a passage through which ink 100 is supplied to the ink chamber 102. The ink channel 104 is connected to an ink tank (not shown), in which ink 100 is stored. The ink 100 may be a dielectric liquid or a conductive liquid.

The pair of electrodes 107a and 107b may be provided on a bottom surface of the ink chamber 102 to be separated from each other. A gap between the electrodes 107a and 107b may be approximately 1 μm to approximately 10 μm. Alternatively, two or more pairs of electrodes may be provided in the ink chamber 102.

In operation, the voltage application unit 110 applies a voltage to generate a plasma discharge caused by liquid ionization between the pair of electrodes 107a and 107b. The voltage applied between the electrodes 107a and 107b may be a direct current pulse voltage or an alternating current pulse voltage. A bubble 120 is then generated and expanded in the ink 100 around the electrodes 107a and 107b by the liquid plasma discharge. Ink 100 in the ink chamber 102 is then ejected out of the printhead through the nozzle 106 due to expansion of the bubble 120. An ejection speed of an ink droplet can be approximately 1 to 50 m/s.

Generally, in order to generate a liquid plasma discharge, when the liquid is pure water, a voltage of greater than approximately 100 MV/m is required, however, when the liquid is a conductive liquid, a voltage of greater than approximately 1 MV/m is required. In addition, the size of a voltage required to generate a liquid plasma discharge is determined according to a shape of the electrodes, an electric conductivity of the ink, a distance between the electrodes, temperature, and pressure.

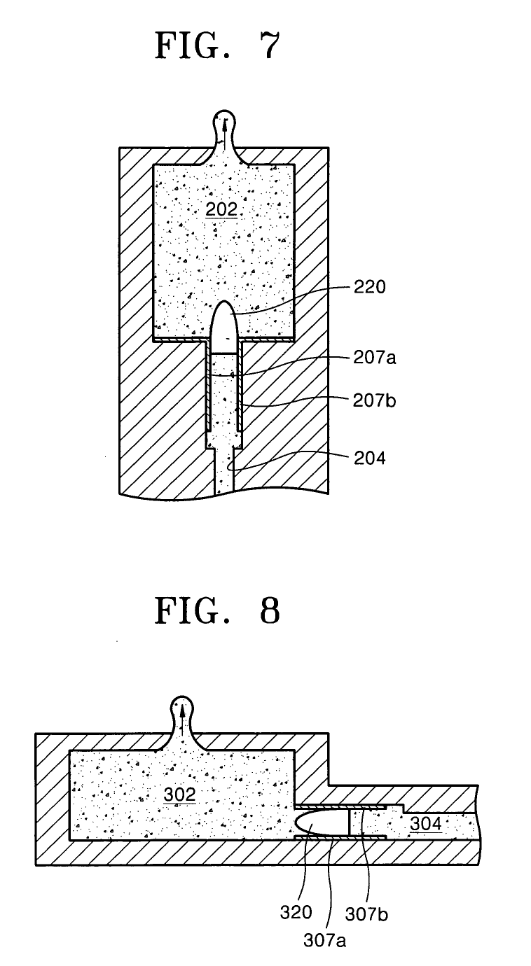

FIGS. 6A through 6C illustrate stages in a droplet ejection process of the ink-jet printhead according to an embodiment of the present invention.

Referring to FIGS. 6A through 6C, an ink ejection process of the ink-jet printhead according to an embodiment of the present invention will be described.

First, referring to FIG. 6A, in a state in which a voltage is not applied between the pair of electrodes 107a and 107b, ink 100 in the ink chamber 102 fills an entrance of the nozzle 106 by a capillary force to form a meniscus. A gap between the electrodes 107a and 107b may be approximately 1 μm to approximately 10 μm. A direct current pulse voltage or an alternating current pulse voltage is then applied between the electrodes 107a and 107b by the voltage application unit 110. A voltage of greater than approximately 1 MV/m may be applied for approximately 0.1 to approximately 10 μs. When a predetermined voltage is applied between the electrodes 107a and 107b, ink 100 around the electrodes 107a and 107b is ionized. Resultantly, current flows between the electrodes 107a and 107b via the ionized ink 100, thereby inducing a plasma discharge.

Referring to FIG. 6B, bubble 120 is generated and expanded between the electrodes 107a and 107b by the plasma discharge. Thus, ink 100 in the ink chamber 102 is forced through the nozzle 106.

Referring to FIG. 6C, the applied voltage is interrupted when the bubble 120 has maximally expanded. When the applied voltage is interrupted, the bubble 120 contracts gradually until it dissipates, and the ink 100 forced through the nozzle 106 is ejected out of the printhead in an ink droplet 100′. An ejection speed and an ejection volume of the ink droplet 100′ may be controlled by the voltage applied between the electrodes 107a and 107b and a pulse period thereof. Subsequently, the ink chamber 102 is refilled with ink 100, the printhead is returned to an initial state, and the above process is repeated.

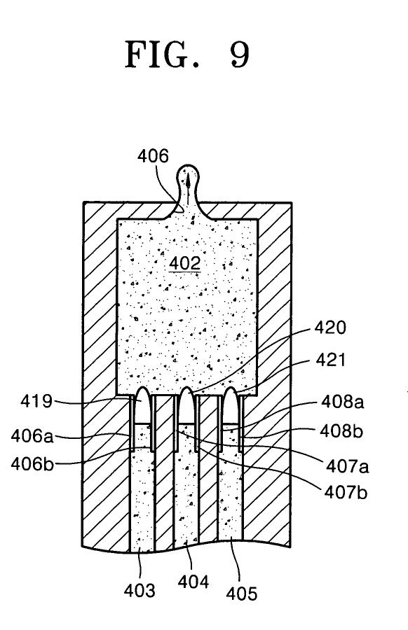

FIGS. 7 through 9 illustrate various modifications of the ink-jet printhead according to an embodiment of the present invention. Only differences from the above mentioned embodiment will be described.

Referring to FIG. 7, an ink flow path may include an ink chamber 202 and an ink channel 204. Each of a pair of electrodes 207a and 207b is provided in a single body on a bottom of the ink chamber 202 and on interior walls of the ink channel 204 connected to the ink chamber 202. When a predetermined voltage to generate a liquid plasma discharge is applied between the electrodes 207a and 207b, a bubble 220 is generated and expanded, and ink in the ink chamber 202 is ejected out of the printhead through a nozzle 206 due to expansion of the bubble 220.

Referring to FIG. 8, a pair of electrodes 307a and 307b may be provided on interior walls of an ink channel 304 connected to an ink chamber 302. In operation, a bubble 320 is generated and expanded between the electrodes 307a and 307b by a liquid plasma discharge.

Referring to FIG. 9, an ink flow path may include an ink chamber 402 and a plurality of ink channels 403, 404, and 405. Multiple pairs of electrodes (406a and 406b), (407a and 407b), and (408a and 408b) may be respectively provided on interior walls of the ink channels 403, 404, and 405 connected to the ink chamber 402. In operation, when a predetermined voltage to generate a liquid plasma discharge is applied between the multiple pairs of electrodes (406a and 406b), (407a and 407b), and (408a and 408b), respective bubbles 419, 420, and 421 are generated and expanded, and ink in the ink chamber 402 is ejected through a nozzle 406 due to expansion of the bubbles 419, 420, and 421.

As described above, an ink-jet printhead according to an embodiment of the present invention may have one or more of the following advantages.

First, since ink is ejected by bubbles generated by a liquid plasma discharge, an ink-jet printhead may have a simplified configuration that does not require a heater or a piezoelectric element.

Second, since a defect generated by deterioration of a heater in a conventional printhead is prevented, a lifetime of a printhead can be increased.

Third, since bubbles generated by a liquid plasma discharge are used to eject ink, the ejectivity of ink may be very large and generation of a harmful gas may be prevented.

Fourth, there is no restriction on properties such as photosensitivity and conductivity with relation to ink that may be used.

Exemplary embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1. An ink-jet printhead, comprising:
an ink flow path having a nozzle for ejecting ink;
at least one pair of electrodes provided in the ink flow path, each of the at least one pair of electrodes being separated from each other; and
a voltage application unit for applying a voltage between the at least one pair of electrodes to generate a plasma discharge caused by liquid ionization between the pair of electrodes to generate a bubble for ejecting the ink.

2. The ink-jet printhead as claimed in claim 1, wherein the ink is one of a dielectric liquid and a conductive liquid.

3. The ink-jet printhead as claimed in claim 1, wherein a gap between the at least one pair of electrodes is approximately 1 μm to approximately 10 μm.

4. The ink-jet printhead as claimed in claim 1, wherein one of a direct current pulse voltage and an alternating current pulse voltage is applied between the at least one pair of electrodes.

5. The ink-jet printhead as claimed in claim 1, wherein the voltage applied between the at least one pair of electrodes is greater than approximately 1 MV/m.

6. The ink-jet printhead as claimed in claim 1, wherein the voltage is applied between the at least one pair of electrodes for a time of approximately 0.1 to approximately 10 μs.

7. The ink-jet printhead as claimed in claim 1, wherein the ink flow path comprises:
an ink chamber to be supplied with ink to be ejected through the nozzle; and
an ink channel to supply ink to the ink chamber.

8. The ink-jet printhead as claimed in claim 7, wherein the at least one pair of electrodes is provided in the ink chamber.

9. The ink-jet printhead as claimed in claim 8, wherein the at least one pair of electrodes is provided on a bottom surface of the ink chamber.

10. The ink-jet printhead as claimed in claim 7, wherein the at least one pair of electrodes is provided in the ink channel.

11. The ink-jet printhead as claimed in claim 7, wherein the at least one pair of electrodes is provided in the ink chamber and the ink channel.

12. The ink-jet printhead as claimed in claim 1, wherein the at least one pair of electrodes is a plurality of pairs of electrodes.

13. The ink-jet printhead as claimed in claim 12, wherein the ink flow path comprises:
an ink chamber to be supplied with ink to be ejected through the nozzle; and
a plurality of ink channels to supply ink to the ink chamber,
wherein one pair of the plurality of pairs of electrodes is provided in each of the plurality of ink channels.
